(19) United States
(12) Patent Application Publication
(10) Pub. No.: US 2004/0078976 A1
(43) Pub. Date: Apr. 29, 2004

(54) Stainless steel honeycomb panel and method for manufacturing thereof

(76) Inventors: Young-Moon Ahn, Kyoungki-do (KR); Seung-Sun You, Taejeon (KR); Soo Chic, Taejon (KR)

Correspondence Address: LATHROP & GAGE LC, 2345 GRAND AVENUE, SUITE 2800, KANSAS CITY, MO, 64108, US

(21) Appl. No.: 10/333,540

(22) PCT Filed: Jan. 19, 2001
(86) PCT No.: PCT/KR01/00093

(30) Foreign Application Priority Data
Jul. 19, 2000 (KR) 2000/41433

(51) Int. Cl. B23P 17/00

(52) U.S. Cl. 29/897.32; 52/783.1; 428/118

(57) ABSTRACT

The present invention relates to the stainless steel honeycomb building interior and exterior finish which can be used semipermanently and, in particular, to the stainless steel honeycomb panel made using stainless steel which is excellent in durability, not rusted and separation does not occur under any external circumstances, and to the method and apparatus of manufacturing thereof. The conventional stainless steel honeycomb panel is manufactured by placing honeycomb between stainless steel panels and by fixing them using adhesives. This method however, has the disadvantage that separation occurs easily due to the external temperature and humidity and so has limitation when used as building external finishes. In the present invention, stainless steel honeycomb panel is produced by coinciding sheet of solder type lead on one side of stainless steel panel with flux on both sides, placing, honeycomb between stainless steel panels wherein lead coincided side is to the inner side, and heating both sides of stainless steel panel directly or indirectly at the temperature of 200° C.˜300° C. while pressing with press.

### TECHNICAL FIELD

The present invention relates to a stainless steel honeycomb panel used in a building construction's exterior or interior finish work, and more particularly to a stainless steel honeycomb panel along with the method and device for its manufacture, said panel being one which, made of a pair of stainless steel plates with a stainless steel honeycomb inserted in-between and joined tightly by means of soldering, is of both strength and durability nearly semipermanent.

### BACKGROUND OF ART

For the present the panels used for the metal interior or exterior finish work for medium-sized or large building constructions are honeycomb panels either of aluminum or stainless steel.

In the case of aluminum honeycomb panels, they are made of an aluminum honeycomb inserted between two plates of aluminum and fixed tightly to them by an adhesive. Because, in the case of aluminum honeycomb panels, the aluminum honeycomb inside and the aluminum plates outside are only adhered to each other with an adhesive, there is little trouble in their production, but as time goes by, the thus manufactured aluminum panels, especially when used in the exterior finish and exposed to the outdoor air for long, cannot but suffer from the oxidation of the adhesive, while the cracks, if minute, which are caused when the material is bent or folded to suit the needs, considerably lessen their durability.

Aluminum is weak against salts, and so aluminum honeycomb panels may last shorter when they are used in seaside areas than otherwise.

To remedy these shortcomings stainless steel, stronger and more durable than aluminum, is used, but in this case, too, the same method of manufacture as in the case of aluminum honeycomb panels is used, that is, an adhesive is used for adhesion of the stainless steel honeycomb and stainless steel plates, and a passivity coat or membrane of iron and chrome is formed on the surface of the stainless steel, considerably degrading the adhesion, often causing even exfoliation at exposure to the outdoor atmosphere.

For this reason, some of the existing stainless steel honeycomb panels are manufactured of a pair of stainless steel plates and an aluminum honeycomb, which latter is inserted between the plates and adhered to them by an adhesive, but the resultant panel's durability is not as good as is desired, because adhesion between the two heterogeneous materials can hardly be anything ideal.

### DISCLOSURE OF INVENTION

The present invention is intended to solve the problems inherent in the existing aluminum honeycomb panels or stainless steel honeycomb panels by the manufacture of a stainless steel honeycomb panel with the use of stainless steel, a material much stronger and greatly more durable than aluminum, that is, by preparing a stainless steel plate; setting next to said plate a sheet of solder doped with the flux on both surfaces; placing a stainless steel honeycomb on said sheet of solder; mounting another sheet of solder, also doped on both surfaces with a flux, on top of said honeycomb; placing another stainless steel plate on top of all these; and finally pressing, from both top and bottom, the pile of all these together in a press; device, and heat-welding the entire structure, preferably at 200° C.˜300° C., by the operation of the heaters placed inside said press.

The present invention has solved the problems, especially of exfoliation, inherent in the use of adhesives in the manufacture of stainless steel honeycomb panels, by inserting on both sheets of solder doped with a flux by heat-welding the layers afterwards.

### BRIEF DESCRIPTION OF DRAWINGS

FIG. 1 is a perspective view of the stainless steel honeycomb panel, cut open, of the present invention.

FIG. 2 is a rough vertical section view of the stainless steel honeycomb panel of the present invention, showing a sheet of solder doped with a flux on both surfaces.

FIG. 3 is a vertical section view of the stainless steel honeycomb panel of the present invention, showing how it looks before the honeycomb panel is adhered to another stainless steel plate.

FIG. 4 is an illustration showing a part of the device of the present invention for pressing and heat-welding the stainless steel honeycomb with the stainless steel plates.

FIG. 5 is a flow chart to show an embodiment example of the method for manufacture of the stainless steel honeycomb panel of the present invention.

### BEST MODE FOR CARRYING OUR THE INVENTION

Below, a best example of the embodiment of the present invention, that is, the stainless steel honeycomb panel along with the method and device for its manufacture, is described in detail, the drawings being referred to as required.

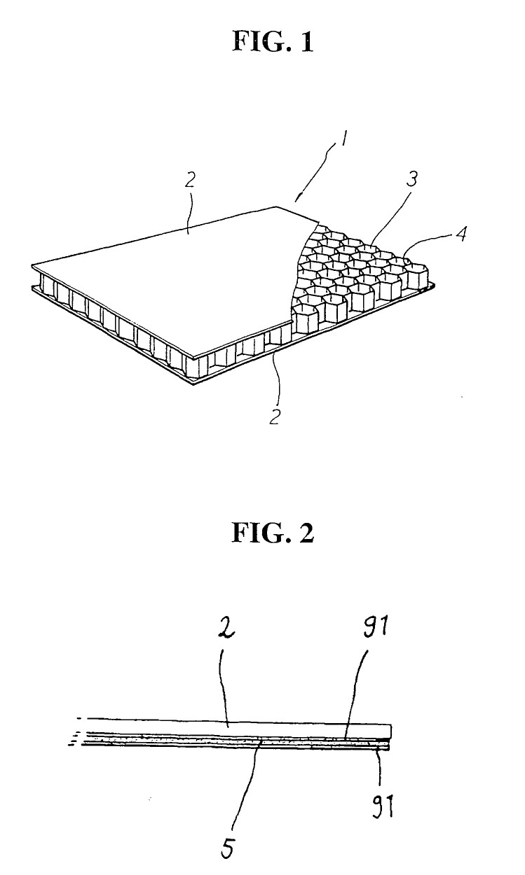

In the manufacture of the stainless steel honeycomb panel of the present invention, two stainless steel plates (2, 2′) ate placed, as seen in FIG. 1, facing each other and a stainless steel honeycomb 3 is inserted between said two stainless steel plates (2, 2′), and in this way a stainless steel honeycomb panel 1 is formed.

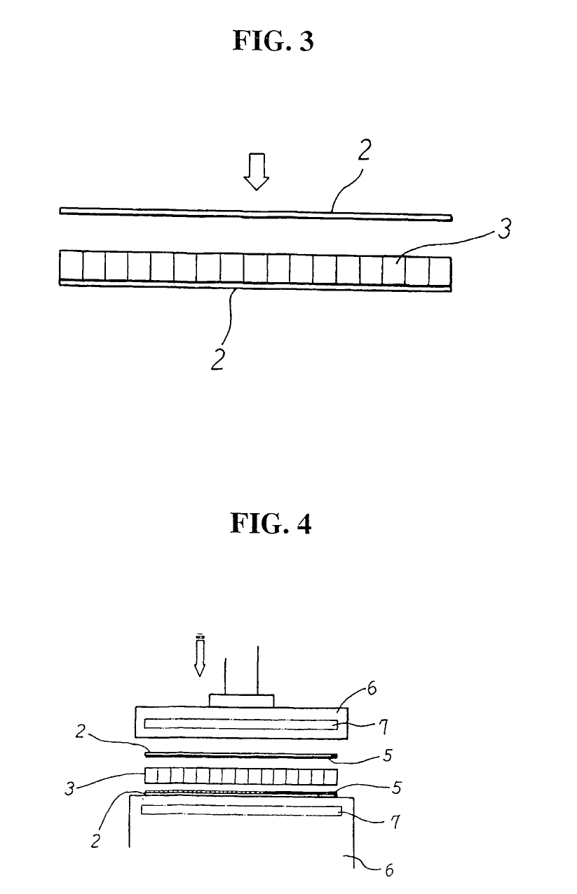

Then as is shown in FIG. 2, solder 5, doped with a flux 91, a solvent, on both surfaces, is placed between the stainless steel honeycomb 3, also doped with a flux 91, and the stainless steel plate 2. Now, as is shown in FIG. 3, the stainless steel plate 2 having solder 5 doped with a flux 91 on both surfaces under itself and the other stainless steel plate 2′, having another solder 5′ also doped with a flux 91 over itself, are so placed that the solder (5, 5′) will face each other; and then the stainless steel honeycomb 3, doped with a flux 91 on both surfaces of contact, is inserted between said two stainless steel plates to come into contact with them via the solder 5 above and the other solder 5′ below; and the stainless steel honeycomb is pressed and heat-welded with the stainless steel plates (2, 2′).

The solder 5 doped with a flux 91 is most preferably used in the form of a sheet.

In short, the stainless steel plates (2, 2′) are placed on the outermost sides and the stainless steel honeycomb 3 is inserted between them 2, 2″ via the solders (5, 5′); the adhesion of the stainless steel honeycomb 3 and the stainless steel plates (2, 2′) is effected by the sheets of solder (5, 5′) doped with a flux 91 on both surfaces. The adhesion of each wall 4 of each hole of the honey comb 3 with those of its neighbors is done with commonly known adhesives or by means of spot welding.

Here the adhesion of the stainless steel honeycomb 3 and the stainless steel plates (2, 2′) must be done firmly by the sheets of solder (5, 5′) doped with a flux 91, while the adhesion of each wall 4 of contact of each hole of the stainless steel honeycomb with the neighbors need not be very firm but should still be strong enough for the walls not to come off.

That is, because the stainless steel honeycomb 3 is firmly fixed as the solder 5 and the flux 91 melt and harden, the walls of each hole of the honeycomb may be adhered to each other only firmly enough to keep their shapes.

The stainless steel plates (2, 2′) and the stainless steel honeycomb 3 in the present invention are welded by the use of the flux 91 and the solder 5 in the form of a sheet at a low temperature, and therefore no exfoliation can occur at any extraneous conditions, and as the adhesion of them takes place at a low temperature no vestige or trace of adhesion is left behind on the outer surface of the plates to mar its beautiful appearance.

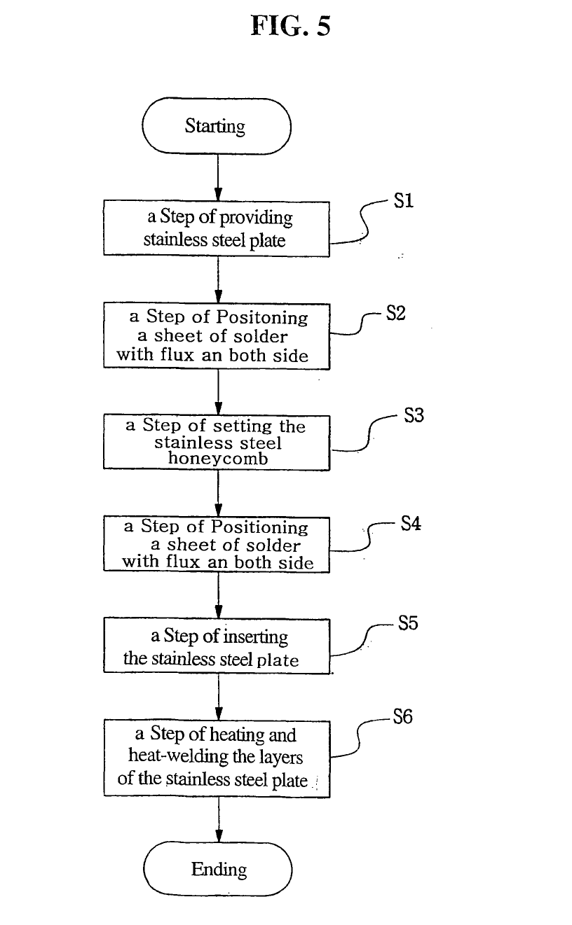

To elaborate the method for manufacture of the stainless steel honeycomb panel 1 of the present invention, it begins, as is shown in FIG. 4 and the flow chart, FIG. 5, with the supply (S1) of stainless steel plates cut in appropriate sizes, followed by the doping (S2) of these plates (2, 2′) with a flux 91 on their inner surfaces.

Then the sheets of solder (5, 5′) doped with the flux on both surfaces are placed next to the stainless steel plates (2, 2′) (S 3).

Then the stainless steel plate 2, with a sheet of solder 5 doped with flux 91 on both surfaces, placed under it, and the other stainless steel plate 2′, with another sheet of solder 5′ also doped with a flux 91 on both surfaces, placed on top of it, are so set inside a press 6 that the sheets of solder (5, 5′) will come into contact (S4).

The stainless steel honeycomb 3 is inserted between the two stainless steel plates (2, 2′) via the two sheets of solder (5, 5′) (S5).

The two stainless steel plates (2, 2′) and the stainless steel honeycomb 3 are pressed and heat-welded, preferably at 200° C.˜300° C., with the use of heaters (7, 7′) installed inside the press 6. (S6)

Now the flux 91 can be doped either on the inside surfaces of the stainless steel plates (2, 2′) and on both contact surfaces of the stainless steel honeycomb 3 or on both surfaces of the two sheets of solder (5, 5′). Either way will do, provided that the flux 91 is applied between the two stainless steel plates (2, 2′), the sheets of solder (5, 5′), and the stainless steel honeycomb 3.

Above, a preferable embodiment example of the present invention consisting of the stainless steel honeycomb panel along with the method and device for its manufacture has been described, but the present invention is not confined to this example of embodiment but all its possible variations shall belong to the range of the present invention.

The present invention provides a method and device for the manufacture of a stainless steel honeycomb panel for use in the interior or exterior finishing of construction buildings, which is strong, stainless, effective in resistance against salts, and for these reasons can be made of greatly thinner material stuff than in the case of conventional aluminum honeycomb panels and yet, in durability, nearly semipermanent.

As the present invention uses strong and durable stainless steel no cracks are caused even if the product is bent or folded, and so it is possible to provide an effect of incorrodibleness.

And because the present invention uses the same material stuff, stainless steel, in both plates and honeycomb, it is possible to provide an incomparably improved effect, compared with the conventional stainless steel honeycomb panel which uses stainless steel plates but aluminum for the honeycomb.

What is claimed is:

1. A stainless steel honeycomb panel, which is manufactured by placing two different stainless steel plates (2, 2′), each doped with a flux 91, a solvent, on the inner surface and having a solder (5, 5′) next to it, so that the surface of a solder will face that of the other; inserting a stainless steel honeycomb 3 also doped with a flux 91 on the both surfaces between the solder (5, 5′); and pressing and heat-welding all these layers.

2. The stainless steel honeycomb panel according to claim 1, wherein said solder (5, 5′) is in the shape of a sheet.

3. A stainless steel honeycomb panel whose stainless steel plates and stainless steel honeycomb are made of the same stainless steel.

4. A method for manufacturing a stainless steel honeycomb panel, which comprises the steps of:
(a) providing two stainless steel plates (2, 2′) cut out into a certain size;
(b) positioning a sheet of solder (5, 5′) doped with a flux 91 on both;
(c) setting the two stainless steel plates (2, 2′) so that their surfaces fixed with the sheets of the solder (5, 5′) will face each other, one plate in the upper and the other in the lower side of a press 6;
(d) inserting the stainless steel honeycomb 3 between the sheets of solder (5, 5′); and,
(e) heating and heat-welding the layers of the stainless steel plates (2, 2′) together with the inserted stainless steel honeycomb panel 3 by operating the heaters (7, 7′) inside the press 6.

5. A device comprising a press, inside which the stainless steel plates each having a sheet of solder doped with a flux on both surfaces are to be placed, one in the upper and the other in the lower part; and a heater, formed inside the press, to heat the stainless steel plates and, after the stainless steel honeycomb is inserted between said stainless steel plates, tightly to join said stainless steel plates and said stainless steel honeycomb by heat-welding them while pressing them with the press.
